(19) United States
(12) Patent Application Publication
(10) Pub. No.: US 2021/0252951 A1
(43) Pub. Date: Aug. 19, 2021

(54) RETRACTABLE WINDSHIELD

(71) Applicant: JGHARVEY SOLUTIONS LLC, Roswell, GA (US)

(72) Inventor: Jeff Grady Harvey, Roswell, GA (US)

(21) Appl. No.: 17/175,535

(22) Filed: Feb. 12, 2021

Related U.S. Application Data
(60) Provisional application No. 62/976,722, filed on Feb. 14, 2020.

(51) Int. Cl. B60J 1/06; B63B 19/00

(52) U.S. Cl. CPC B60J 1/06; B63B 2019/0038; B63B 19/00

(57) ABSTRACT

A retractable windshield for a boat includes a main windshield section having a closed configuration in which the main windshield section is substantially vertically oriented in front of a driving position within the center console and an open configuration in which the main windshield section is substantially horizontally oriented above the driving position and adjacent to the rooftop. The main windshield section is configured to rotationally transition from the closed configuration to the open configuration in response to a force applied to a bottom portion of the main windshield section in a direction away from the driving position and upward.

### CROSS-REFERENCE TO RELATED APPLICATION

This application claims priority to U.S. Provisional Patent Application Ser. No. 62/976,722, filed Feb. 14, 2020, entitled, “RETRACTABLE WINDSHIELD,” and the disclosure of which is hereby incorporated by reference in its entirety.

### BACKGROUND

Conventional boat or marine windshields are fixed in place, sometimes rotating downward or upward around hinges positioned along a bottom or top edge of the windshield, or sliding downwards or upwards like an automobile window. Marine windshields that rotate around hinges positioned along a bottom or top edge tend to split the front windshield into a top section and a bottom section such that the top section folds over the bottom section when opened. A problem with these types of windshields is that the hinged edge is undesirably positioned in a middle portion of the complete windshield. In doing so, the hinged edge may interfere with a driver or passenger's clear view through the windshield. Moreover, when opened, due to the size of the bottom portion of the windshield, incoming air may be undesirably impeded. Additionally, rotating the top section of the windshield downward may interfere with or inconvenience passengers seated in front of the windshield.

Similarly, windshields that raise and lower like an automobile window limit the configuration of the boat cockpit to a lower cockpit section that shares the same planar configuration as the windshield so that the windshield can lower into the lower cockpit section when opened. Consequently, there is a need for improved retractable marine windshields that maximize incoming airflow when opened, provides an unobstructed view when closed, and allows for various cockpit design configurations. Various embodiments of the present retractable windshield recognize and address the foregoing considerations, and others, of prior art devices.

### SUMMARY

It should be appreciated that this Summary is provided to introduce a selection of concepts in a simplified form that are further described below in the Detailed Description. This Summary is not intended to be used to limit the scope of the claimed subject matter.

According to one aspect of the disclosure, a retractable windshield includes a main windshield section and a windshield retraction mechanism. The windshield retraction mechanism includes a number of vertically oriented tracks configured for positioning within a cockpit of a boat forward of a driving position of a driver of the boat, a number of horizontally oriented tracks configured for positioning within the cockpit of the boat above the driving position, a first number of sliding mechanisms coupled to a mid-section of the main windshield section and configured to engage the vertically oriented tracks, and a second number of sliding mechanisms coupled to a top portion of the main windshield section and configured to engage the horizontally oriented tracks. The main windshield section and the windshield retraction mechanism are configured such that force applied to a bottom portion of the main windshield section in a direction away from the driving position of the driver of the boat and upward is operative to linearly translate the first number of sliding mechanisms upward within the vertically oriented tracks and to linearly translate the second number of sliding mechanisms rearward within the horizontally oriented tracks such that the main windshield section rotates upward and rearward to from a closed configuration in front of the driving position of the driver of the boat to an open configuration above the driving position of the driver of the boat.

According to another aspect of the disclosure, a retractable windshield for a boat includes a center console of the boat having a frame. A number of vertically oriented tracks are configured for positioning within the frame forward of a driving position of a driver of the boat. A number of horizontally oriented tracks are configured for positioning within the frame above the driving position. The retractable windshield further includes a main windshield section, a first number of sliding mechanisms coupled to a mid-section of the main windshield section and configured to engage the vertically oriented tracks, and a second number of sliding mechanisms coupled to a top portion of the main windshield section and configured to engage the horizontally oriented tracks. The retractable windshield is configured such that in response to a force applied to a bottom portion of the main windshield section in a direction away from the driving position of the driver of the boat and upward, the main windshield section linearly translates the first number of sliding mechanisms upward within the vertically oriented tracks and to linearly translate the second number of sliding mechanisms rearward within the horizontally oriented tracks such that the main windshield section rotates upward and rearward to from a closed configuration in front of the driving position of the driver of the boat to an open configuration above the driving position of the driver of the boat.

According to yet another aspect of the disclosure, a retractable windshield for a boat includes a center console of the boat having a frame and a rooftop, and a main windshield section. The main windshield section has a closed configuration in which the main windshield section is substantially vertically oriented in front of a driving position within the center console. The main windshield section also has an open configuration in which the main windshield section is substantially horizontally oriented above the driving position and adjacent to the rooftop. The main windshield section is configured to rotationally transition from the closed configuration to the open configuration in response to a force applied to a bottom portion of the main windshield section in a direction away from the driving position and upward.

### BRIEF DESCRIPTION OF THE DRAWINGS

Various embodiments of the disclosure will be described below. In the course of the description, reference will be made to the accompanying drawings, which are not necessarily drawn to scale, and wherein:

FIG. 1 is a perspective view of a retractable windshield in a closed configuration, according to various embodiments described herein.

FIG. 2A is a perspective view of a retractable windshield in an open configuration, according to various embodiments described herein.

FIG. 2B is a perspective view of a retractable windshield in an open configuration having a fixed lower windshield, according to various embodiments described herein.

FIG. 3 is a side cross-sectional view of a boat having a retractable windshield in a closed configuration, according to various embodiments described herein.

FIG. 4 is a side cross-sectional view of a boat having a retractable windshield in an open configuration, according to various embodiments described herein.

FIG. 5 is a perspective view of a retractable windshield in an open configuration with a supplemental fixed windscreen, according to various embodiments described herein.

FIG. 6 is a perspective view of a retractable windshield in a closed configuration, according to an alternative embodiment described herein.

FIG. 7 is a perspective view of a retractable windshield in an open configuration, according to an alternative embodiment described herein.

### DETAILED DESCRIPTION OF VARIOUS EMBODIMENTS

Various embodiments will now be described more fully hereinafter with reference to the accompanying drawings. It should be understood that the concepts disclosed herein may be embodied in many different forms and should not be construed as limited to the embodiments set forth herein. Rather, these embodiments are provided so that this disclosure will be thorough and complete, and will fully convey the scope of the disclosure to those skilled in the art. Like numbers refer to like elements throughout.

As discussed above, conventional boat windshields do not readily open and close, or do not do so in a straightforward manner to provide an unobstructed view in open and closed configurations, while allowing for abundant airflow and out-of-the-way positioning when opened with unlimited cockpit design configurations. The concepts and technologies described herein allow for the main center portion of a boat windshield to slide backward at the top and upward at the bottom so the windshield transitions from the traditionally vertical position oriented in front of the boat captain when in a closed configuration to a substantially horizontal overhead position that suspends above the captain's head when in an open configuration.

The overhead position in the open configuration allows the windshield to be positioned up and out of the way for almost all practical purposes to allow for the free flow of air, communications, unobstructed view, reflection for night-time navigation, and physical access. Depending on the vertical height of the retractable portion of the windshield, it may extend partially out of the cabin forward of the original position of the windshield as needed when up and in the open position. According to one embodiment, the retractable windshield is connected on each side proximate the top corners and at the mid-section to sliders or rollers that glide along rigid rails to move from the forward closed position up to the overhead open position (and back when moving to a closed position). This design includes safety latches to ensure windshield is secure in both open and closed positions. According to an alternative embodiment, the retractable windshield is connected on each side proximate the top corners, allowing the windshield to be rotated outward at the bottom to an open configuration.

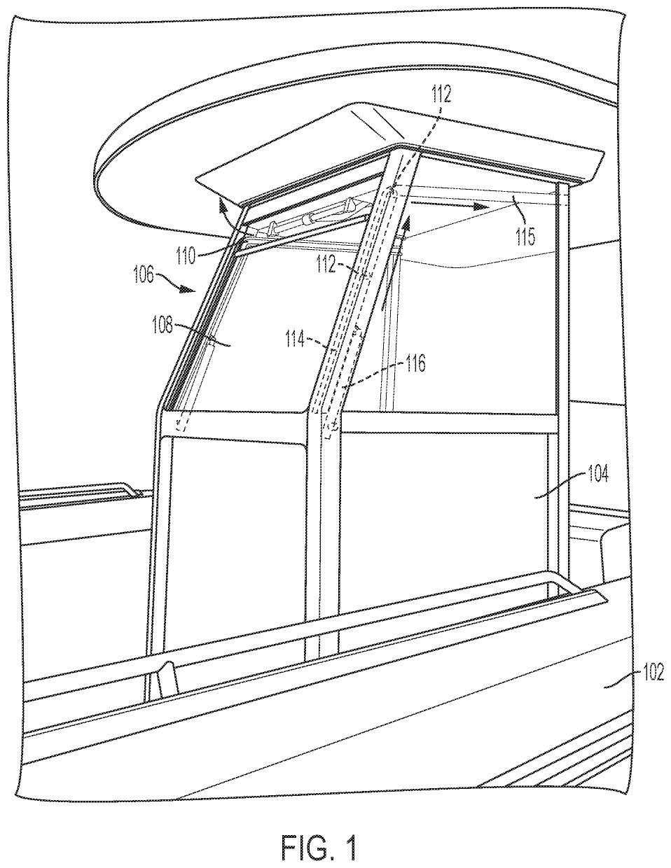

Referring now to FIGS. 1-5, aspects of a retractable windshield 106 will be discussed in detail, according to various embodiments. For illustrative purposes, these embodiments will be discussed in the context of installation in a center console 104 or cockpit/cabin of a boat 102. It should be understood that the retractable windshield 106 described herein is not limited to use with a center console 104 configuration, or even to use on a boat 102. Rather, the various concepts described herein may be utilized with any vehicle or equipment in which a windshield that transitions between open and closed configurations is desired.

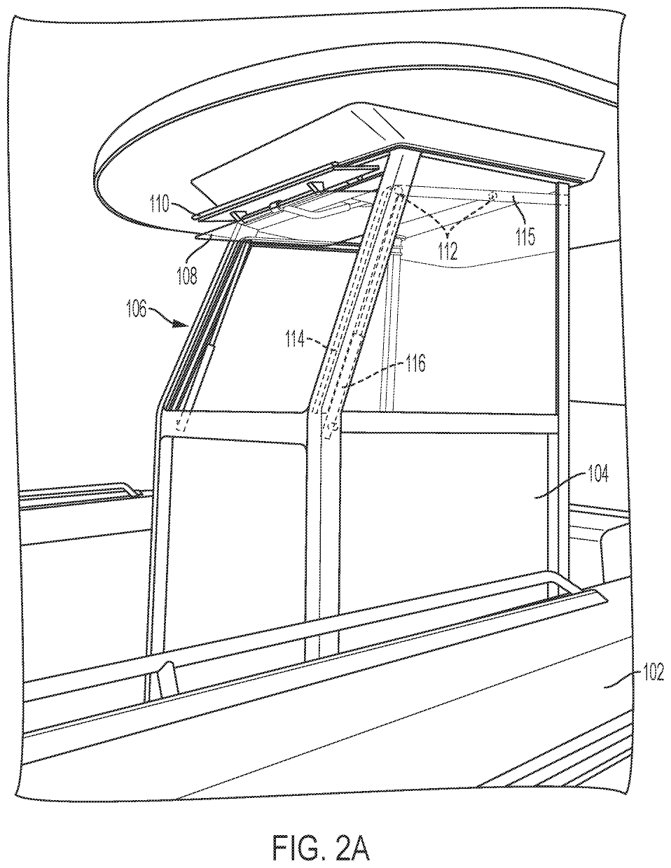

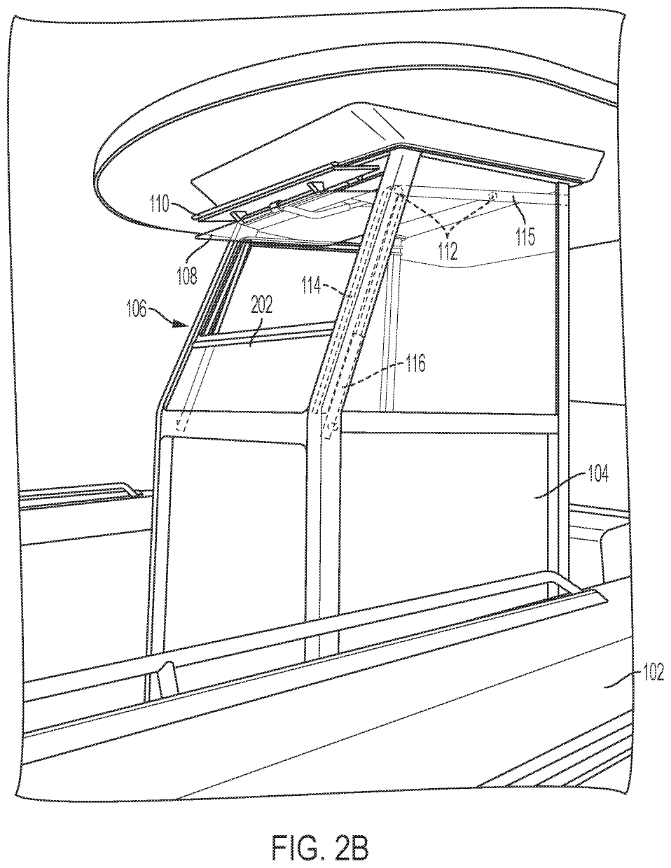

FIG. 1 shows the retractable windshield 106 in a closed configuration that blocks the wind from the cockpit. FIG. 2A shows the retractable windshield 106 in an open configuration that allows wind to pass through the cockpit of the boat 102. The retractable windshield 106 may include a main windshield section 108 that is moveable between closed and open configurations. As will be described herein with respect to various embodiments, the retractable windshield 106 may additionally include one or more additional windshield components positioned adjacent to or proximate to the main windshield section 108. These additional windshield components may remain fixed to block incoming wind from that portion of the retractable windshield 106, or may be capable of opening or repositioning to provide a vent that allows the incoming wind to pass through.

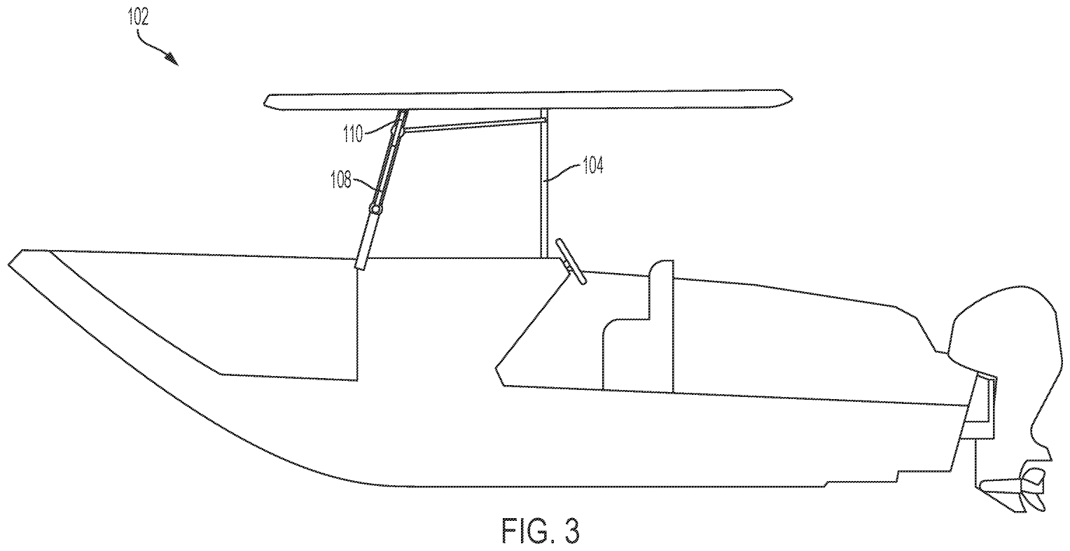

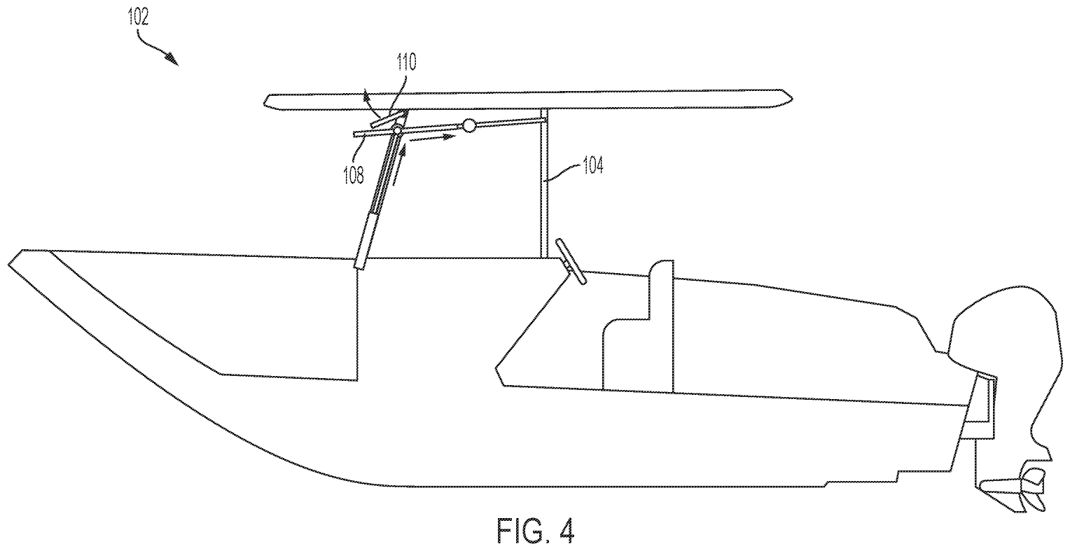

For example, FIGS. 1 and 2A show a vent 110 that is positioned adjacent to and above the main windshield section 108. The vent 110 is moveable between the closed configuration shown in FIGS. 1 and 3, and the open configuration shown in FIGS. 2A and 4, as indicated by the curved arrows in the various drawings. The vent 110 may be hinged along a top edge such that an opposite bottom edge may pivot outwards to the open configuration, allowing for ventilation when the main windshield section 108 is in place or to increase the windshield opening when the main windshield section 108 is fully opened. Any suitable mechanisms for securing the vent 110 in the open and the closed configurations may be utilized. Alternatively, the vent 110 may be hinged along a bottom edge, one or more side edges, and/or may slide in any direction to open and close. According to one embodiment, the vent 110 is approximately eight inches in height from the roof down to the main windshield section 108, but any height may be used without departing from the scope of this disclosure.

To open and close the main windshield section 108, a windshield retraction mechanism is used. The windshield retraction mechanism includes vertically oriented rails or tracks 114, horizontally oriented rails or tracks 115, and wheels, rollers, or other sliding mechanisms 112 that are configured to engage the tracks to hold the main windshield section 108 in place within the center console 104 framing, while allowing the main windshield section 108 to slide within the tracks for opening and closing. Specifically, the frame around the retractable windshield 106 includes the vertically oriented tracks 114, along with the horizontally oriented tracks 115 positioned proximate to the roof line or top portion of the center console 104. For the purposes of this disclosure, “vertically oriented” means oriented parallel to the plane of the main windshield section 108, which may be vertical or may be oriented at an acute angle to vertical as shown. Similarly, “horizontally oriented” means oriented substantially horizontally, or at substantially small angles from horizontal. For clarity purposes, only the vertically oriented tracks 114, horizontally oriented tracks 115, and sliding mechanisms 112 on one side of the center console 104 are numbered in the drawings. It should be understood that both side edges of the main windshield section 108 engage the center console 104, so there are complimentary pairs of vertically oriented tracks 114 and horizontally oriented tracks 115 on both sides of the center console 104 with corresponding sliding mechanisms 112 on both side edges of the main windshield section 108.

Specifically, according to various embodiments, sliding mechanisms 112 are connected proximate to top corners on opposing sides of the main windshield section 108 and are engaged with the horizontally oriented tracks 115. Similarly, sliding mechanisms 112 are connected near the mid-section of opposing sides of the main windshield section 108 and are engaged with the vertically oriented tracks 114. Handles (not shown) are attached to the main windshield section 108 for manually opening and closing the windshield.

To open, a user within the cockpit pulls (gripping the one or more handles) on an upper portion of the main windshield section 108 while simultaneously sliding the windshield upward, as indicated by the arrows in FIG. 1. In doing so, the sliding mechanisms 112 at the top corners of the main windshield section 108 linearly translate rearward along the horizontally oriented tracks 115. Simultaneously, the sliding mechanisms 112 near the mid-section of the main windshield section 108 linearly translate upward along the vertically oriented tracks 114. This movement rotates the lower portion of the main windshield section 108 outward and upward, while moving the top portion of the main windshield section 108 rearward. The resulting overhead open position of the main windshield section 108 places the open windshield above the driver's head, out of the way of all passengers and opening the large space in front of the driver to allow unimpeded airflow through the cockpit. As best seen in FIGS. 2A and 4, the lower portion of the main windshield section 108 extends outward from the cockpit. To close the main windshield section 108, the reverse process is initiated, pulling the windshield forward and downward to pivot the lower portion of the main windshield section 108 downward to the closed configuration.

To aid the user in lifting the main windshield section 108, one or more hydraulic cylinders 116 or other mechanical actuators may be utilized. The hydraulic cylinders 116 may be mounted to the center console 104 structure proximate to the lower end of the main windshield section 108 with the distal ends of the piston rods of the hydraulic cylinders 116 coupled to the main windshield section 108 below the lower sliding mechanisms 112. It should be appreciated that any type of actuators may be used to assist with opening the main windshield section 108 without departing from the scope of this disclosure. The actuators may be electrically driven to open and close the windshield without user assistance, or may be configured to provide assistance to the user when manually opening and closing the windshield. Any number and type of safety latches (not shown) may be used to manually or electronically secure the main windshield section 108 in the open or closed configuration, or at any position in between.

FIG. 2B shows a perspective view of a retractable windshield 106 in an open configuration and having a fixed lower windshield section 202. The fixed lower windshield section 202 may be an optional configuration in which the main windshield section 108 does not extend all the way down to the base of the windshield opening. Rather, the base of the windshield opening includes a fixed lower windshield section 202 that provides a permanent deflection of wind and/or rain when the main windshield section 108 is open. The bottom edge of the main windshield section 108 abuts or is positioned adjacent to the top edge of the fixed lower windshield section 202 when positioned in the closed configuration. Alternatively, the main windshield section 108 may extend all the way down to the base of the windshield opening, as described above with respect to FIG. 1, overlapping the fixed lower windshield section 202, which may be mounted slightly rearward of the main windshield section 202.

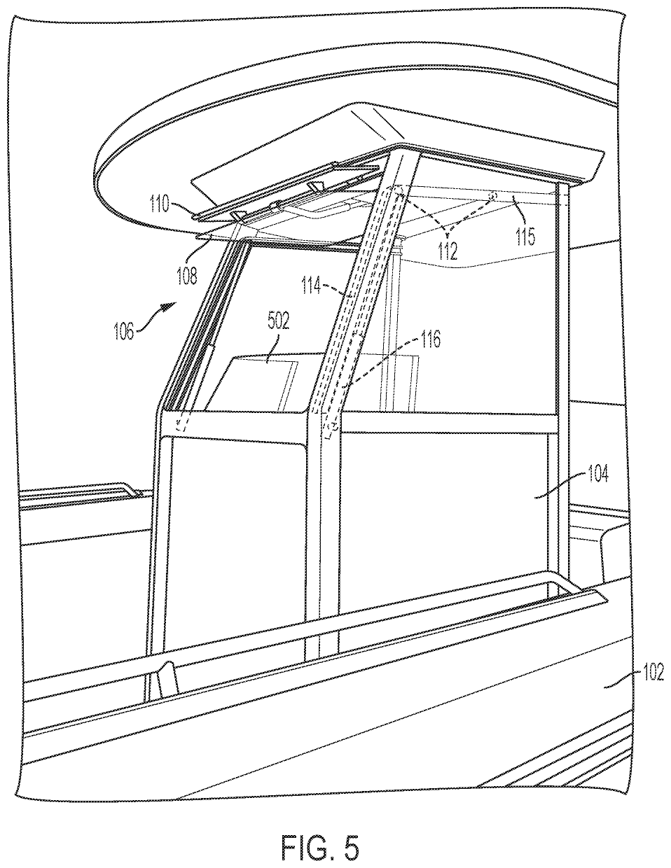

Turning now to FIG. 5, an alternative embodiment will be described. This embodiment is similar to that described above with respect to FIG. 2B having a fixed lower windshield section 202. However, rather than a fixed lower windshield section 202 that is positioned within the windshield opening, this example utilizes a fixed lower wrap-around windshield section 502. The fixed lower wrap-around windshield section 502 provides a permanent deflection of wind and/or rain when the main windshield section 108 is open. The fixed lower wrap-around windshield section 502 at least partially wraps around the cockpit area to provide protection from wind and water, allowing for a dashboard space on which the driver or passengers may place items to protect them from the elements or from being blown away (e.g. a cellular telephone, keys, map, etc.). The fixed lower wrap-around windshield section 502 is separate from the main windshield section 108 and other windshield components, providing a stand-alone lower windshield that supplements the retractable windshield 106 components described above.

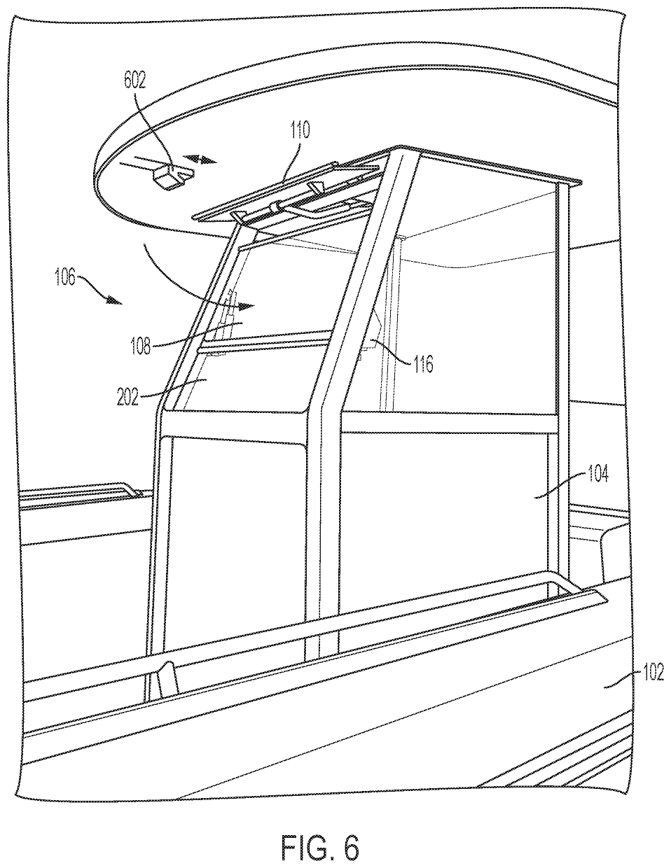

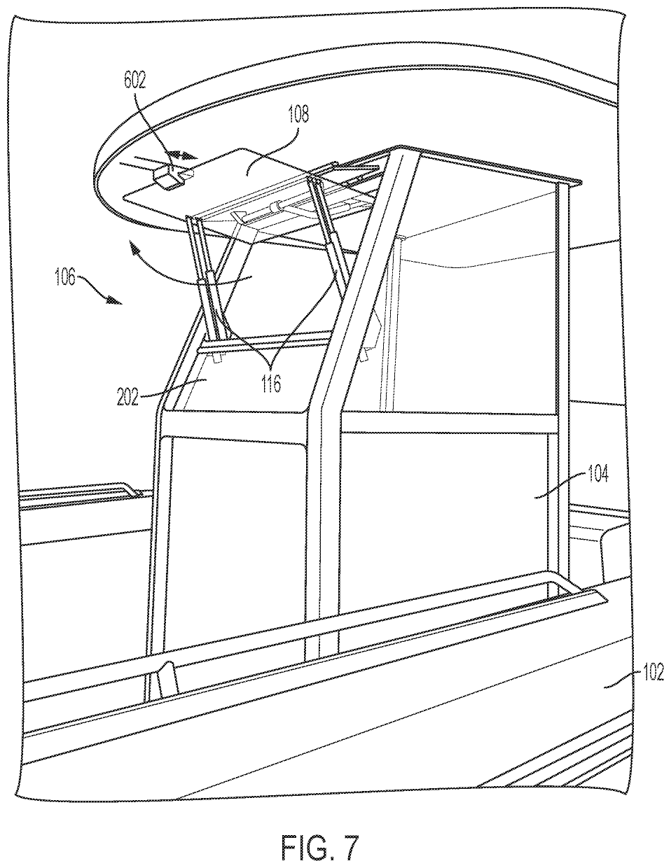

FIGS. 6 and 7 show perspective views of a retractable windshield 106 in closed and open configurations, respectively, according to alternative embodiments. In this embodiment, the retractable windshield 106 includes a main windshield section 108 that is hinged along a top edge or at the upper corners and pushes outward from a bottom edge to transition from the closed configuration of FIG. 6 to the open configuration of FIG. 7, as indicated by the curved lines. This example also includes a vent 110 and a fixed lower windshield section 202, similar to the embodiments described above.

The overhead position of the open configuration is up and out of the way for almost all practical purposes and allows for the free flow of air, unimpeded communications with passengers in and out of the cabin or cockpit, an unobstructed view, removal of reflections for night-time navigation, and physical access. The embodiment includes a soft rubber grip or other windshield engagement mechanism 602 on the underside of the rooftop that slides backward to grip the outside edge of the extended main windshield section 108 in the open configuration and slides forward to release the main windshield section 108 to allow it to close, as indicated by the arrows in FIGS. 6 and 7. The windshield engagement mechanism 602 ensures that the raised windshield is stable in rough conditions. This embodiment also includes safety latches to ensure that the main windshield section 108 is secure in both open and closed positions. The safety latches may be configured to lock the windshield engagement mechanism 602 in the engaged position when securing the main windshield section 108 in the open configuration. It should be understood that the windshield engagement mechanism 602 may include any mechanism that is configured to engage and secure the main windshield section 108 in place in the open configuration and is not limited to the slidable rubber grip shown in FIGS. 6 and 7. For example, alternative windshield engagement mechanisms 602 may include any number of fasteners, straps, or magnets. According to another example, rather than a grip or other mechanism coupled to the rooftop that engages the windshield, the windshield engagement mechanism 602 includes a locking functionality of the hydraulic cylinders 116 to lock the piston rods in place and prevent the windshield from lowering.

As previously discussed, to aid the user in lifting the main windshield section 108, one or more hydraulic cylinders 116 or other mechanical actuators may be utilized. Due to the weight of the main windshield section 108 of this embodiment being rotated outward to the open configuration, multiple hydraulic cylinders 116, or hydraulic cylinders 116 having a “double barrel” design style with two piston rods may be used. Any number and type of actuator or lifting assist mechanism may be used to assist in the electrically-activated or manual lifting of the main windshield section 108 to the open configuration.

### CONCLUSION

Many modifications and other embodiments of the disclosure will come to mind to one skilled in the art to which this disclosure pertains having the benefit of the teachings presented in the foregoing descriptions and the associated drawings. For example, as will be understood by one skilled in the relevant field in light of this disclosure, the disclosure may take form in a variety of different mechanical and operational configurations. Therefore, it is to be understood that the disclosure is not to be limited to the specific embodiments disclosed herein, and that the modifications and other embodiments are intended to be included within the scope of the appended exemplary concepts. Although specific terms are employed herein, they are used in a generic and descriptive sense only and not for the purposes of limitation.

What is claimed:

1. A retractable windshield, comprising:
a main windshield section; and
a windshield retraction mechanism, comprising:
a plurality of vertically oriented tracks, each vertically oriented track configured for positioning within a cockpit of a boat forward of a driving position of a driver of the boat;
a plurality of horizontally oriented tracks, each horizontally oriented track configured for positioning within the cockpit of the boat above the driving position of the driver of the boat;
a first plurality of sliding mechanisms coupled to a mid-section of the main windshield section and configured to engage the plurality of vertically oriented tracks; and
a second plurality of sliding mechanisms coupled to a top portion of the main windshield section and configured to engage the plurality of horizontally oriented tracks,
wherein the main windshield section and the windshield retraction mechanism are configured such that force applied to a bottom portion of the main windshield section in a direction away from the driving position of the driver of the boat and upward is operative to linearly translate the first plurality of sliding mechanisms upward within the plurality of vertically oriented tracks and to linearly translate the second plurality of sliding mechanisms rearward within the plurality of horizontally oriented tracks such that the main windshield section rotates upward and rearward to from a closed configuration in front of the driving position of the driver of the boat to an open configuration above the driving position of the driver of the boat.

2. The retractable windshield of claim 1, further comprising a vent positioned above the main windshield section and configured to rotatably open and close.

3. The retractable windshield of claim 1, further comprising a fixed lower windshield section.

4. The retractable windshield of claim 3, wherein the fixed lower windshield section comprises an upper edge that is positioned adjacent to or abutting a lower edge of the main windshield section when the main windshield section is positioned in the closed configuration.

5. The retractable windshield of claim 3, wherein the fixed lower windshield section comprises a fixed lower wrap-around windshield section that at least partially wraps around the driving position of the driver of the boat.

6. A retractable windshield for a boat, comprising:
a center console of the boat, the center console comprising a frame;
a plurality of vertically oriented tracks, each vertically oriented track configured for positioning within the frame forward of a driving position of a driver of the boat;
a plurality of horizontally oriented tracks, each horizontally oriented track configured for positioning within the frame above the driving position of the driver of the boat;
a main windshield section;
a first plurality of sliding mechanisms coupled to a mid-section of the main windshield section and configured to engage the plurality of vertically oriented tracks; and
a second plurality of sliding mechanisms coupled to a top portion of the main windshield section and configured to engage the plurality of horizontally oriented tracks,
wherein in response to a force applied to a bottom portion of the main windshield section in a direction away from the driving position of the driver of the boat and upward, the main windshield section is configured to linearly translate the first plurality of sliding mechanisms upward within the plurality of vertically oriented tracks and to linearly translate the second plurality of sliding mechanisms rearward within the plurality of horizontally oriented tracks such that the main windshield section rotates upward and rearward to an open configuration above the driving position of the driver of the boat.

7. A retractable windshield for a boat, comprising:
a center console of the boat, the center console comprising a frame and a rooftop;
a main windshield section having
a closed configuration in which the main windshield section is substantially vertically oriented in front of a driving position within the center console, and
an open configuration in which the main windshield section is substantially horizontally oriented above the driving position and adjacent to the rooftop,
wherein the main windshield section is configured to rotationally transition from the closed configuration to the open configuration in response to a force applied to a bottom portion of the main windshield section in a direction away from the driving position and upward.
